(19) United States
(12) Patent Application Publication
(10) Pub. No.: US 2026/0143299 A1
(43) Pub. Date: May 21, 2026

(54) SYSTEM AND METHOD FOR IDENTIFYING GEOGRAPHIC LOCATIONS IN PROXIMITY TO ANOTHER LOCATION IN REVERSE GEO-SEARCHING

(71) Applicant: Precisely Software Incorporated, Burlington, MA (US)

(72) Inventors: Mohammed Taboun, Calgary (CA); Michael Ashmore, Boulder, CO (US)

(21) Appl. No.: 18/953,493

(22) Filed: Nov. 20, 2024

(51) Int. Cl. H04W 4/021

(52) U.S. Cl. CPC H04W 4/021

(57) ABSTRACT

Described herein are systems and methods for listing a number of geographic locations that are closest in proximity to an input or current location. Techniques described herein reduce the amount of the total geographic area whose associated geographic data has to be searched for generating the list by applying a randomized clustering approach which recursively divides the space into quadrants (or sections) and sub-quadrants (or sub-sections) and removes the problem of neighbors being separated by bounding borders by creating a series or forest of randomized quad-trees. The probabilistic nature of the randomized forests reduces the probability of the bounding border problem to be close to negligible.

### TECHNICAL FIELD

The disclosure herein relates to geographic location systems and methods. More particularly, the disclosure herein relates to an efficient method of identifying a list of geographic locations closest in proximity to a current or input location.

### BACKGROUND

Geolocation is a ubiquitous feature that many smart phone providers, mobile and web application providers/developers, telecommunication companies, social media companies and many other enterprises use on a daily basis to determine the location of customers and other people, places, and things around the world. Global positioning systems (GPS), map applications (e.g., Google Maps, Apple Maps, Waze, etc.) as well as ride share and delivery companies (e.g., Uber, Lyft, Amazon, etc.) use location determination on a regular basis to determine where people, buildings, homes, and other things are located on a daily basis to deliver goods and services or to tell consumers where they are located to provide directions for the consumers to where they wish to go.

Geocoding is a term that refers to translating a human-readable address (e.g., street address, mailing address, postal address, etc.) into a location (e.g., latitude and longitude) on a map. Reverse geocoding is a process by which the location on the map is translated into a human-readable address. A reverse geo-search is an expansion on the concept of reverse geocoding, in which the latitude and longitude of a location is used to identify the location based on a location input. Unlike reverse geocoding that returns the location of the input geocode in human-interpretable format, reverse geo-search returns the human name of any number of locatable objects (sometimes referred to as points of interest) that meet the search criteria using the input location as a geographic central searching location.

Current practice for reverse geo-searching requires the use of spatial analysis on numerous layers of spatial data. To complete this task the distance between the coordinates of the input and all objects in the dataset are calculated. The results may then be passed through a filter with a maximum distance which reduces the number of results returned. Finally, the results can be ordered by a criterion, such as their distances from the target point (e.g., a current location of a person, place or thing on a map).

Some methods have been used to reduce the search space (e.g., reducing the amount of the total geographic area whose associated geographic data has to be searched and compared with the geographic data of a given input or current location), such as defining bounds and only searching within the bounds. This requires defining the bounds a priori, and determining which locations belong to which bounds—as a form of clustering the data. The bounds that the target coordinate lies in is then assigned. The challenge with bounding occurs when a coordinate lies near the edge of the bounds. Locations which are very close but lay on the opposing side of a bounds will not be compared when looking for neighboring or close nodes.

As such, there is a need for improved systems and methods for addressing some of the above-mentioned deficiencies.

### SUMMARY

In an embodiment of the present disclosure, a method is disclosed that includes indexing, by a processing circuit, a plurality of geographic locations within a geographic area into one or more search trees, wherein the one or more search trees is stored in a database. In some embodiments, each of the one or more search trees is a data structure divided into a plurality of first data sections, and each of the plurality of first data sections is divided into a plurality of second data sections, wherein indexing the plurality of geographic locations into the one or more search trees includes various operations. For example, in some embodiments, indexing the plurality of geographic location includes selecting a plurality of first random geographic locations from the plurality of geographic locations. In some embodiments, indexing the plurality of geographic location includes dividing the geographic area into a plurality of first sections, the plurality of first sections sharing a first midpoint of the first random geographic locations as a first shared vertex, and each of the plurality of first sections of the geographic area corresponding to a first data section in a search tree. In some embodiments, indexing the plurality of geographic location includes selecting a plurality of second random geographic locations within each of the plurality of first sections. In some embodiments, indexing the plurality of geographic location includes dividing each of the plurality of first sections into a plurality of second sections, each of the plurality of first sections including corresponding second sections sharing a second midpoint of the second random geographic locations within a corresponding first section as a second shared vertex, and each of the plurality of second sections of the geographic area corresponding to a second data section in the search tree. In some embodiments, indexing the plurality of geographic location includes assigning each of the plurality of geographic locations to a second data section of the search tree that corresponds to the second section within which the geographic location is located. In some embodiments, the method further includes receiving, by the processing circuit, a request, including an input location, to determine a list of locations within the geographic area that are closest in proximity to the input location. In some embodiments, the method further includes accessing, by the processing circuit, the database and searching the one or more search tree to determine which of the plurality of second data sections of the search tree the input location is located within. In some embodiments, the method further includes populating the list of locations with the geographic locations assigned to a same second data section of the search trees to which the input location is assigned.

In another aspect, a computing apparatus is provided. In some embodiments, the computing apparatus includes a processing circuit and a memory storing executable instructions thereon which, when executed by the processing circuit, configure the processing circuit to perform various functions. In some embodiments the processing circuit is configured to index a plurality of geographic locations within a geographic area into one or more search trees, wherein the one or more search trees is stored in a database. In some embodiments, each of the one or more search trees is a data structure divided into a plurality of first data sections, and each of the plurality of first data sections is divided into a plurality of second data sections, wherein indexing the plurality of geographic locations includes the processing circuit being configured to perform various operations described herein. For example, in some embodiments, the processing circuit is further configured to select a plurality of first random geographic locations from the plurality of geographic locations. In some embodiments, the processing circuit is further caused to divide the geographic area into a plurality of first sections, the plurality of first sections sharing a first midpoint of the first random geographic locations as a first shared vertex, and each of the plurality of first sections of the geographic area corresponding to a first data section in a search tree. In some embodiments, the processing circuit is further configured to select a plurality of second random geographic locations within each of the plurality of first sections. In some embodiments, the processing circuit is configured to divide each of the plurality of first sections into a plurality of second sections, each of the plurality of first sections including corresponding second sections sharing a second midpoint of the second random geographic locations within a corresponding first section as a second shared vertex, and each of the plurality of second sections of the geographic area corresponding to a second data section in the search tree. In some embodiments, the processing circuit is configured to assign each of the plurality of geographic locations to a second data section of the search tree that corresponds to the second section within which the geographic location is located. In some embodiments, the processing circuit is configured to receive, by the processing circuit, a request, including an input location, to determine a list of locations within the geographic area that are closest in proximity to the input location. In some embodiments, the processing circuit is configured to access, by the processing circuit, the database and searching the one or more search tree to determine which of the plurality of second data sections of the search tree the input location is located within. And in some embodiments, the processing circuit is configured to populate the list of locations with the geographic locations assigned to a same second data section of the search trees to which the input location is assigned.

In another aspect, a non-transitory computer-readable storage medium is provided. In some embodiments, the computer-readable storage medium includes instructions that when executed by a processing circuit, cause the processing circuit to index a plurality of geographic locations within a geographic area into one or more search trees, wherein the one or more search trees is stored in a database. In some embodiments, each of the one or more search trees is a data structure divided into a plurality of first data sections, and each of the plurality of first data sections is divided into a plurality of second data sections, wherein indexing the plurality of geographic locations includes the processing circuit being configured to perform various operations described herein. For example, in some embodiments, the processing circuit is configured to select a plurality of first random geographic locations from the plurality of geographic locations. In some other embodiments, the processing circuit is configured to divide the geographic area into a plurality of first sections, the plurality of first sections sharing a first midpoint of the first random geographic locations as a first shared vertex, and each of the plurality of first sections of the geographic area corresponding to a first data section in a search tree. In some embodiments, the processing circuit is configured to select a plurality of second random geographic locations within each of the plurality of first sections. In some embodiments, the processing circuit is configured to divide each of the plurality of first sections into a plurality of second sections, each of the plurality of first sections including corresponding second sections sharing a second midpoint of the second random geographic locations within a corresponding first section as a second shared vertex, and each of the plurality of second sections of the geographic area corresponding to a second data section in the search tree. In some embodiments, the processing circuit is configured to assign each of the plurality of geographic locations to a second data section of the search tree that corresponds to the second section within which the geographic location is located. In some embodiments, the processing circuit is configured to receive, by the processing circuit, a request, including an input location, to determine a list of locations within the geographic area that are closest in proximity to the input location. In some embodiments, the processing circuit is configured to access, by the processing circuit, the database and searching the one or more search tree to determine which of the plurality of second data sections of the search tree the input location is located within. In some embodiments, the processing circuit is configured to populate the list of locations with the geographic locations assigned to a same second data section of the search trees to which the input location is assigned.

### BRIEF DESCRIPTION OF THE DRAWINGS

By way of example, specific embodiments of the disclosed methods and devices will now be described, with reference to the accompanying drawings, in which:

FIG. 1 illustrates a map of a geographic area in accordance with some embodiments.

FIG. 2A illustrates an example system in accordance with some embodiments.

FIG. 2B illustrates an example system in accordance with some embodiments.

FIG. 3A illustrates an example geographic area being indexed in accordance with some embodiments.

FIG. 3B illustrates an example geographic area being indexed in accordance with some embodiments.

FIG. 3C illustrates an example search forest in accordance with some embodiments.

FIG. 4 illustrates an example search tree map in accordance with some embodiments.

FIG. 5 illustrates an example system in accordance with some embodiments.

FIG. 6A is a flow chart illustrating a method in accordance with some embodiments.

FIG. 6B is a flow chart illustrating a method in accordance with some embodiments.

It should be understood that the drawings are not necessarily to scale and that the disclosed embodiments are sometimes illustrated diagrammatically and in partial views. In certain instances, details which are not necessary for an understanding of the disclosed methods and devices, or which render other details difficult to perceive may have been omitted. It should in be further understood that this disclosure is not limited to the particular embodiments illustrated herein. In the drawings, like numbers refer to like elements throughout unless otherwise noted.

### DETAILED DESCRIPTION

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Embodiments of the present disclosure will now be described more fully hereinafter with reference to the accompanying drawings, in which several exemplary embodiments are shown. The subject matter of the present disclosure, however, may be embodied in many different forms and types of methods and devices, and should not be construed as limited to the embodiments set forth herein. Rather, these embodiments are provided so that this disclosure will be thorough and complete, and willfully convey the scope of the subject matter to those skilled in the art. In the drawings, like numbers refer to like elements throughout.

Described herein are systems and method for identifying geographic locations in proximity to another location in reverse geo-searching. Some embodiments of the present disclosure act to reduce the search space (e.g., reducing the amount of the total geographic area whose associated geographic data has to be searched and compared with the geographic data of a given input or current location) by applying a randomized clustering approach which recursively divides the space into quadrants (or sections) and sub-quadrants (or sub-sections), and removes the problem of neighbors being separated by bounding borders by creating a series or forest of randomized quad-trees. The probabilistic nature of the randomized forests reduces the probability of the bounding border problem to be close to negligible.

The systems and techniques described herein represent a form of unsupervised hierarchical clustering, where training follows a similar pattern to machine learning approaches. Within the tree (described in more detail below), each node of the tree represents a given space, which contains data. The random division uses recursive logic described in more detail below. This process is referred to as “indexing” hereinbelow. Once the search space and the geographic locations therein have been indexed, the indexed locations can then be used to minimize the search space to determine locations closest to a current location and other features of the geographic area.

The systems and methods described herein provide improvements over existing systems because it decreases the amount of search space (e.g., data) in the geographic location data that is required to be searched through to determine locations closest to an input or current location of a user. That is, by using the disclosed approach, search time, memory utilization, and performance of the computer or processing circuit (e.g., of a GPS, location server, application server, etc.) performing the searching are all improved over prior systems. Moreover, by randomizing the forest of trees described herein, the disclosed system represents an improvement over existing technologies by overcoming the current limitations of the border or boundary issues described above which prevents neighbors which are divided by borders to not be recognized.

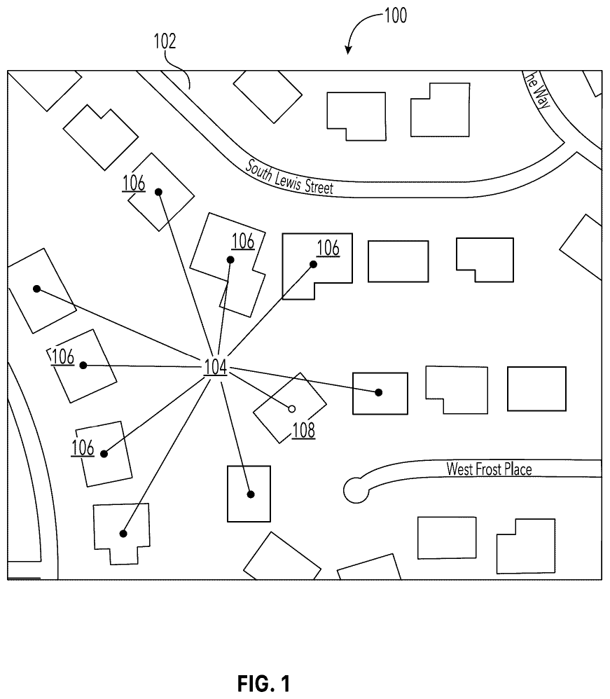

FIG. 1 is an example geographic area 100 depicted visually using a map 102 of the geographic area 100. For example, FIG. 1 includes a current location 104 of a user (e.g., person, vehicle, robot, etc.) of the map 102. The user is surrounded by various objects at one or more geographic locations 106 around the current location 104 of the user. An “object” is any physical or non-physical geospatially identifiable point, line or polygon (e.g., representing houses, buildings, stores, offices, etc.) that is indexed as described herein. The systems and techniques described herein are provided to determine a list of candidate locations that are closest to the current location 104. For example, the systems and techniques described herein will provide to the user a list of the buildings or objects closest in proximity to the current location 104, including the nearest geographic location 108 at the top of the list of candidate locations (e.g., the list is sorted in order from closest to furthest from the current location 104).

In some embodiments, the systems and techniques described herein will return a list of objects closest to the user that fit a certain criteria. For example, the user may input a query to the system to determine the closest gas stations, or restaurants, or approved tire repair locations that are closest to the current location 104 of the user.

The systems and techniques described herein deliver an automated, performant, personalized and customized, location context analysis based on an input location (e.g., the current location 104 of the user). For each location entry (e.g., latitude and longitude), the systems provided herein will return a list of candidate “objects” that have been indexed. The input request can specify the number of objects to return and the type of objects that are acceptable. For example, the systems described herein can be configured to ignore residential addresses and non-food serving businesses when looking for the nearest 20 restaurants.

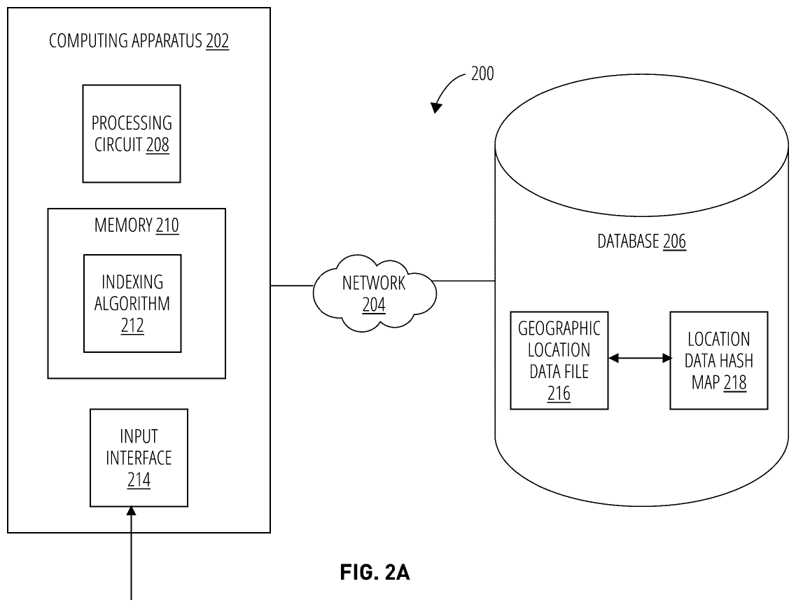

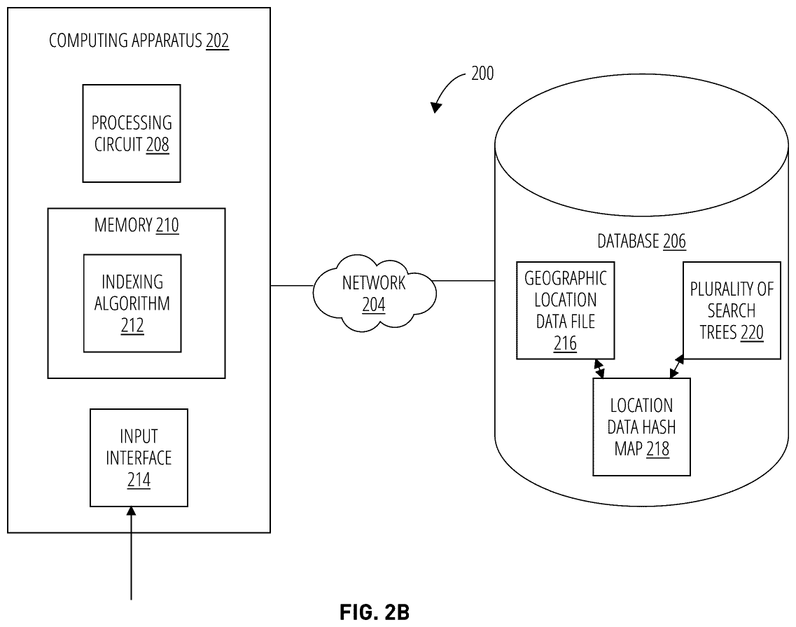

FIG. 2A is a block diagram of an example system 200 according to some embodiments of the present disclosure. FIG. 2A illustrates the system 200 in a state prior to any indexing of the geographic location data file 216 described herein. The term “indexing” refers to generating one or more search trees to help search the geographic location data file 216 to determine a list of candidate geographic locations that are closest in proximity to an input location. Indexing the geographic location data file 216 reduces the proportion of the geographic location data file 216 that has to be searched to determine the list of candidate geographic locations that are closest in proximity to the input location.

In some embodiments, the system 200 includes a computing apparatus 202 connected to a network 204 which provides wired or wireless communication between the computing apparatus 202 and a database 206. In some embodiments, the network 204 is a wired network, such as a local area network (LAN) using switches, routers, and cables. In other embodiments, the network 204 is a wireless network such as a wireless LAN (WLAN) or a mobile communications network (e.g., 3G, 4G, LTE, 5G, 6G, etc.).

In some embodiments, the computing apparatus 202 is a computing device such as a server, personal computer, table computer, mobile device, smart phone, cell phone, mobile phone, GPS navigation device, or any other suitable computing device. In some embodiments, the database 206 includes a database located on a server, personal computer, cloud server, cloud device, or any other suitable computing device. In some embodiments, the computing apparatus 202 and the database 206 are embodied in the same device (e.g., a server) and the network 204 is not needed. In such an embodiment, the database 206 can be located in memory on the computing apparatus 202 and the processing circuit 208 can perform all of the processing operations described herein.

In some embodiments, the computing apparatus 202 includes a processing circuit 208 such as one or more processors, microprocessors, controllers, application specific integrated circuit (ASIC), etc. The computing apparatus 202 further includes memory 210 having executable instructions stored thereon for the processing circuit 208 to execute. In some embodiments, the memory 210 includes an indexing algorithm 212 for the processing circuit 208 to execute to index the geographic location data file 216 stored in the database 206.

In some further embodiments, the computing apparatus 202 includes an input interface 214 for receiving input from a user of the computing apparatus 202. For example, the input interface 214 may include a keyboard, mouse, graphic user interface (GUI), touch screen, button, keypad, universal serial bus (USB) input slot, or any other suitable input interface 214 for receiving input from a user. The input can be a selection from the user (e.g., a selection, using the mouse or keyboard, from a dropdown feature on a GUI) or an input from a storage device such as an external hard drive or a USB drive, etc. In some embodiments, the input interface 214 can be used by a user of the computing apparatus 202 to provide various inputs such as a number of times the geographic location data file 216 is indexed, a current location of the user or another object, as well as any other suitable inputs as described herein.

In some embodiments, the database 206 is also embodied in a server, personal computer, or other suitable computing device. For the purposes of the following description, the computing apparatus 202 and the database 206 will be described as being embodied in two separate computing devices.

The server maintaining the database 206 can include a processing circuit (not shown) for searching through the geographic location data file 216 and the location data hash map 218. The computing apparatus 202 may send a request for a particular geographic location or list of geographic locations and the database 206 may need to open and search through either or both of the geographic location data file 216 and the location data hash map 218.

In some embodiments, the database 206 includes the geographic location data file 216 and a location data hash map 218. The geographic location data file 216 includes a plurality of geographic locations represented by a unique identifier. The unique identifier can also be referred to as a key. Each unique identifier is a reference to a corresponding data structure entry in the location data hash map 218 stored in the database 206. In some embodiments, each data structure entry corresponds to one of the plurality of geographic locations and includes characteristics of the geographic location to which the unique identifier corresponds. For example, in some embodiments, the characteristics include at least a physical street address, a city, a zip code, a postal code, or a unique location code (e.g., latitude and longitude or a code that refers to a unique latitude and longitude position) for real property associated with the corresponding geographic location.

In other words, the location data hash map 218 includes a plurality of data structures, each data structure corresponding to a distinct geographic location and including the characteristics, such as the physical street address, city, zip, etc. Each data structure entry has a corresponding unique identifier to refer to that data structure entry. For example, a geographic location with physical street address “123 Main St,” city “Adventure City”, and zip code “12345” is embodied in a data structure entry in the location data hash map 218 and the data structure entry has unique identifier “123” (the identifier can be decimal, hexadecimal, or any other suitable format). The location data hash map 218 includes a plurality of these data structure entries, each referring to distinct geographic locations. For example, there may be a data structure entry for “123 Main St” having unique identifier “123” and a separate data structure entry for “125 Main St” having unique identifier “125” associated therewith.

The geographic location data file 216 includes a list of the unique identifiers, each referring to a corresponding geographic location data structure entry in the location data hash map 218. For example, as shown in Table 1 below, the geographic location data file 216 may include a table of unique identifiers such as:

TABLE 1
GEOGRAPHIC LOCATION DATA FILE
123
125

These two entries correspond to “123 Main St” and “125 Main St” data structure entries, respectively, in the location data hash map 218. An example of the location data hash map 218 is provided in Table 2 below.

TABLE 2
LOCATION DATA HASH MAP

| Unique Identifier | Characteristics |
|---|---|
| 123 | 123 Main St |
| | Adventure City |
| | 12345 |
| | Lat: 35.80N \| Long: 78.50W |
| | Restaurant |
| 125 | 125 Main St |
| | Adventure City |
| | 12345 |
| | Lat: 35.81N \| Long: 78.51W |
| | Restaurant |

As such, the processing circuit of the database 206 can perform various searching functions on the geographic location data file 216 and then reference the location data hash map 218 to determine characteristics of the geographic location by looking up the corresponding data structure entry for the geographic location in the location data hash map 218 by searching using the unique identifier. The processing circuit of the database 206 can search through the location data hash map 218 using the unique identifier from the geographic location data file 216 and then return characteristics of the geographic location based on the data structure entry for the corresponding unique identifier found in the location data hash map 218.

As described herein, one example task of the system 200 is to determine, and output, a list of candidate locations that are closest to an input location or current location of a user or object. For example, a person at the current location may desire to find the closest restaurants to the person's current location. However, because the geographic location data file 216 and location data hash map 218 may contain so many locations to search through and compare to the current location, it may take a considerable amount of time and processing resources to determine the list of restaurants closest to the user. As such, the system 200 reduces the amount of data to be searched in the geographic location data file 216, and therefore the search area of the geographic area where the user is searching is reduced by indexing the geographic location data file 216 as described herein.

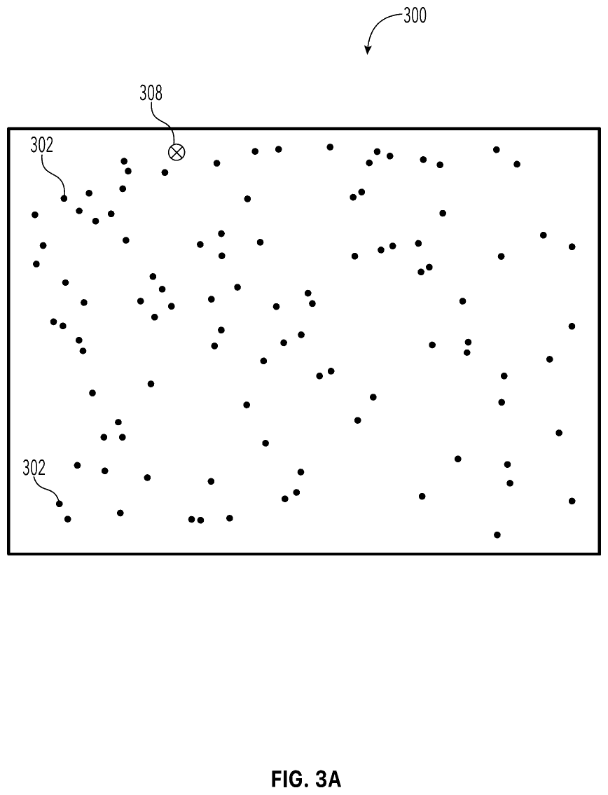

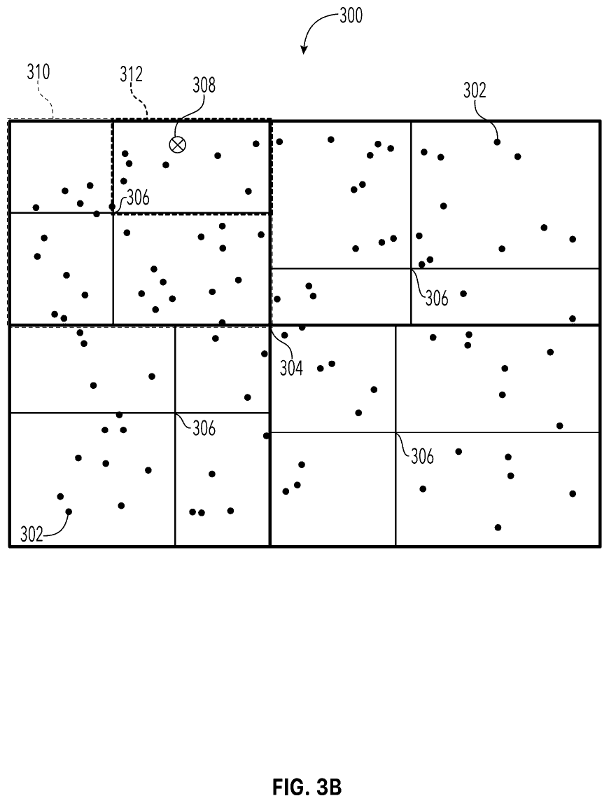

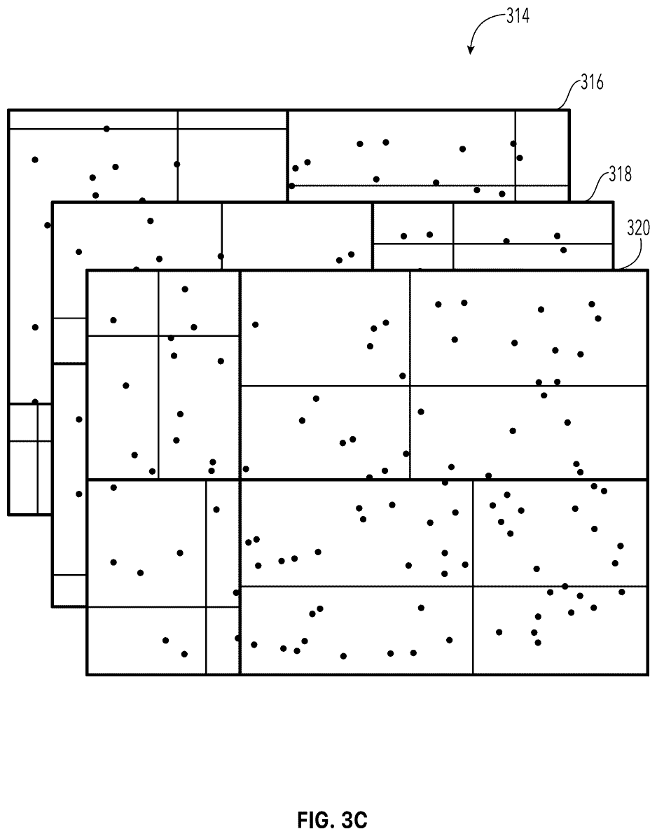

To this end, in some embodiments, the memory 210 includes the indexing algorithm 212 and other executable instructions stored thereon for execution by the processing circuit 208. When executed by the processing circuit 208, the indexing algorithm 212 and other instructions cause the processing circuit 208 to be configured to perform various operations. In some embodiments, the processing circuit 208 is configured to index a plurality of geographic locations located within a geographic area (e.g., geographic locations in the geographic location data file 216 and/or the location data hash map 218) into a plurality of search trees based on a location type of each of the plurality of geographic locations. The location type may include any suitable category. For example, the location type can be restaurants, gas stations, salons, tire repair locations, etc. In some embodiments, each of the plurality of search trees corresponds to a location type of a subset of the geographic locations and the plurality of search trees is stored in the database 206. Example indexing operations are described in further detail in the descriptions of FIG. 3A-FIG. 3C. As described herein, the processing circuit 208 is configured to index the unique identifiers of the plurality of geographic locations in geographic location data file 216 and therefore, the plurality of search trees 220 shown in FIG. 2B includes indexed unique identifiers.

FIG. 2B is a block diagram illustrating a similar system 200 to the system 200 in FIG. 2A, except here, the indexing operations have been performed on the geographic location data file 216 to create a plurality of search trees 220, as described in FIG. 3A-FIG. 3C. The database 206 and the plurality of search trees 220 can be used in various ways. For example, a user may wish to determine the closest restaurants, or other location types, to their current location. In this example, the user will indicate, via the input interface 214, their current location (or it will be determined based on their mobile device's location detection system) or provide another input location. The processing circuit 208 will receive a request from the input interface 214, including an input location and input location type, to determine a list of locations within the geographic area that are closest in proximity to the input location and that have the input location type (e.g., a list of the closest restaurants to the input location or a list of the closes salons). The processing circuit 208 is then configured to access the database 206 and the plurality of search trees 220 and search the search tree in the plurality of search trees 220 having the location type that corresponds to the input location type to determine within which section of the search tree the input location is located. The processing circuit 208 or the processor of the database 206 is then configured to populate the list of locations with the geographic locations (e.g., the unique identifiers assigned to the geographic locations) assigned to the corresponding section of the corresponding search tree in the plurality of search trees 220.

Alternatively, an application, or other automated system, can query the database 206 and the plurality of search trees 220 for a list of the closest, for example, restaurants, and the list of restaurants or other location types will be returned to the application or automated system. Like the geographic location data file 216, the plurality of search trees 220 will include the unique identifiers or keys of the geographic locations and will reference the location data hash map 218 to determine characteristics of the geographic locations, if needed. When a user submits a query that includes the input location, the processing circuit 208 sends the input location to the database 206 and the plurality of search trees 220, which then returns the unique identifiers of the nearest neighbor nodes. Finally, the distance between the input location and each of the nearest neighbors is calculated, and the results are sorted in ascending order before returning to the processing circuit 208 or the user for further analyses. The processing circuit 208 or the processor of the database 206 will then retrieve all of the relevant data for each of the sorted nearest neighbors from the location data hash map 218 based on the unique identifiers in the list. The system 200 can then conduct further spatial analyses or apply filters before returning the list to the user or other applications.

That is, in some embodiments, the processing circuit 208 is further configured to determine a distance between the input location and each of the geographic locations in the list of locations (e.g., those locations output from the plurality of search trees 220), and sort the list of locations based on the distance between the input location and a corresponding geographic location. In some embodiments, the list of locations is sorted from closest to furthest from the input location. The processing circuit 208 can determine the distance from the input location to each of the geographic locations in the list of locations output from the plurality of search trees 220 by comparing the latitude and longitude of the input location to the latitude and longitude of each of the geographic locations in the list found in the location data hash map 218. That is, since the list output from the plurality of search trees 220 is a list of unique identifiers, the processing circuit 208 can query the database 206 to send the latitudes and longitudes for each of the unique identifiers on the list output from the plurality of search trees 220.

In some embodiments, the processing circuit 208 is further configured to output the list of locations, each entry in the list including the unique identifier for the corresponding one of the geographic locations on the list. As described above, the list of unique identifiers is sorted based on distance from the geographic locations to which the unique identifiers correspond to the input location. In some embodiments, the list may also include the distance between each geographic location on the list and the input location.

In some embodiments, the processing circuit 208 is further configured to receive an input parameter, via the input interface 214, indicating a number of geographic locations to list that are closest to the input location. That is, when the processing circuit 208 or the processor of the database 206 is generating the list of the closest geographic locations to the input location, the input parameter can include a limit or minimum to the number of locations that can be included on the sorted list. For example, the input parameter can limit the number of closest locations to one, two, three, five, ten, fifteen, or any other suitable number of locations. In some embodiments, the processing circuit 208 is further configured to only list the locations up to a quantity equal to the input parameter.

FIGS. 3A, 3B, and 3C visually illustrate an example embodiment of indexing the geographic location data file 216 from FIG. 2A and generating the plurality of search trees 220 from FIG. 2B. As described above, indexing the geographic location data file 216 reduces the amount of data in the geographic location data file 216 to be searched in order to perform a reverse geo-search to populate the sorted list of closest geographic locations as described above. While FIG. 3A-FIG. 3C illustrate maps or visual representations of the geographic area 300, this is for illustration purposes only and the actual operations performed are performed by a processing circuit accessing the geographic data in the database 206 that the geographic locations 302 are based on.

FIG. 3A illustrates a graphical representation of a geographic area 300, for example how a user would view the geographic locations 302 on a map. The individual dots mark geographic locations 302, such as houses, restaurants, etc. In some embodiments, indexing occurs for each location type. That is, the geographic locations 302 depicted on FIG. 3A are all of the same location type. For example, they are all restaurants, all residential homes, salons, or tire repair facilities, etc., in the geographic area 300.

As described above, the system 200 can receive an input location such as present location 308 of a user, delivery truck, or other suitable object. In some embodiments, the system 200 from FIG. 2A and FIG. 2B will output the sorted list of locations that includes a list of the geographic locations 302 that are closest in proximity to the present location 308 that also fit the location type received from the input interface 214.

In some embodiments, the indexing operations described herein are performed prior to a user attempting to input their present location 308 and determining the list of closest locations of the particular location type. That is, indexing is performed without regard to a current or input location. After the indexing is performed, thereafter, an input location is received, and then the system 200 queries the indexed search trees described herein to generate the list. Additionally, indexing is performed on a number of different location types. Thus, the plurality of search trees 220 will include a plurality of search trees, each for a different location type.

FIG. 3B illustrates the same geographic area 300 as FIG. 3A, except here, the geographic area 300 has been divided into various sections, for example, quadrants. Each of those quadrants is also divided into quadrants. This will be described in further detail below. However, in some embodiments, the geographic area 300 can be divided into any suitable shapes or numbers of sections. The operations provided herein of how to divide the geographic area 300 are provided as one example embodiment and should not be construed so as to limit the subject matter herein.

In some embodiments, indexing the plurality of geographic locations 302 into the plurality of search trees includes the processing circuit 208 from FIG. 2A being configured to select a plurality of first random geographic locations from the plurality of geographic locations 302. In some embodiments, selecting the plurality of first random geographic locations 302 includes the processing circuit being configured to select four random geographic locations having the location type of the corresponding search tree being indexed (e.g., four random restaurant locations for the restaurant search tree), the first four random geographic locations being non-colinear with respect to each other.

Once the plurality (e.g., four) of random geographic locations are determined, the processing circuit is configured to divide the geographic area 300 into a plurality of first sections, including first section 310 and each of the other larger rectangles illustrated in FIG. 3B. In some embodiments, the plurality of first sections shares a first centroid (in some embodiments the centroid may be a midpoint) of the first random geographic locations as a first shared vertex 304. That is, all of the first sections 310 have a first shared vertex 304 that is located at the centroid (in some embodiments the centroid may be a midpoint) of the four first random geographic locations 302 selected. It should be noted that the two geographic locations 302 highlighted on the geographic area 300 are not necessarily part of the random geographic locations selected, but are instead, just included to refer to the location dots. In some embodiments, the plurality of first sections 310 are first quadrants of the geographic area 300.

As used herein, the term centroid refers to the geometric center point of an object or shape. The centroid may also be defined as the average position of all points on a surface of an object or on a shape. The centroid is determined based on any suitable method currently known or hereinafter discovered.

In some embodiments, the indexing operations include the processing circuit being further configured to select a plurality of second random geographic locations within each of the plurality of first sections 310. Then, each of the first sections 310 is divided into a plurality of second sections. That is, each of the larger rectangles of geographic area 300 having the shared vertex at first shared vertex 304, are further divided into a plurality of second sections much like the plurality of first sections 310 were divided. In some embodiments, each of the plurality of first sections 310 includes a plurality of corresponding second sections 312 sharing a second centroid (in some embodiments the second centroid may be a midpoint) of the second random geographic locations of a corresponding first section as a second shared vertex 306. In some embodiments, selecting the plurality of second random geographic locations within each of the first sections 310 includes the processing circuit being configured to select four random geographic locations within each of the first quadrants (e.g., first sections 310), the plurality of second four random geographic locations being non-colinear with respect to each other. In some embodiments, the second sections 312 are second quadrants within each of the first quadrants (e.g., first sections 310).

In some embodiments, each of the second sections 312 can be further divided just as the geographic area 300 and the first sections 310 were divided. However, for the purposes of this disclosure, the division of the geographic area 300 will end after the second sections 312 are generated. Dividing the geographic area 300 into the first sections 310 and second sections 312 may also be referred to as recursive divisions, whereby the processing circuit recursively divides the geographic area 300 as described above. In some embodiments, the processing circuit can receive an input that includes the number of recursive divisions the geographic area 300 can be subject to for creating the search tree. In some embodiments, the processing circuit is further configured to assign each of the plurality of geographic locations 302 to the corresponding first section 310 and second section 312 within which the geographic location 302 is located. For example, each of the locations represented by the dots within the second section 312 called out in the figure will be assigned to the second section 312 within the first section 310 that is called out.

Once the geographic area 300 has been divided as described above, and each of the geographic locations 302 has been assigned to the corresponding first section 310 and second section 312 within which they are located, this process creates what is referred to as a search tree. Once the user inputs the present location 308, the processing circuit is to determine which of the second sections 312 the current or input location is located within. To determine this, the processing circuit is configured to create hierarchical clusters, where each level of the search tree is divided into quadrants, as described above (e.g., northeast, northwest, southeast, and southwest quadrants). Then, the processing circuit is to traverse down the search tree by first examining the centroid of the layer of the search tree to determine if the current or input location is northwest, northeast, southwest, or southeast of the centroid. This is done by comparing the latitude and longitude of the current or input location to the coordinate values of the centroid. The processing circuit then traverses along the resulting branch of the search tree accordingly.

This process is repeated for every layer of the search tree until there are no further sublayers to traverse down. The bottom sublayer is referred to as the leaf of the search tree structure. Each leaf contains the location coordinates and references to the unique identifiers or keys of all of the other points in the sub-quadrant. These are the points which are returned as candidate search results (which are then computed and ordered by distance from the current or input location). This process is repeated for each of the different trees created in the indexing process, and all the candidates are pooled together in a set (i.e., they are only appended to the set if they don't exist already in the set—to reduce memory footprint and the speed of distance calculations, by ensuring no repeats in the set). The randomness in the indexing process reduces the likelihood of points missing close by candidates due to quadrant bounds. The number of trees and number of layers is a parameter that is tuned or specified during the indexing process which allows a user to optimize the size of the model to prioritize speed over accuracy.

As described above, in some embodiments, the processing circuit is further configured to output all of the other geographic locations 302 in the second section 312 that the present location 308 is located within. These are the geographic locations 302 that are closest to the present location 308. However, the list is also sorted from least to greatest distance between the geographic locations 302 and the present location 308.

FIG. 3C illustrates an example search forest 314 having multiple indexing instances or search trees therein. In some embodiments, it may be desirable to index the geographic area 300 more than once because the geographic locations 302 may have landed on one of the lines separating the sections and therefore been added to multiple sections, or too close to a boundary. As such, in some embodiments, the processing circuit is further configured to receive, as an input parameter, a number of times the plurality of geographic locations 302 are to be indexed. That is, the number of times the plurality of geographic locations 302 for a given location type (e.g., restaurants) is divided into sections as described above, by choosing completely new random geographic locations 302. In some embodiments, the processing circuit can receive the input parameter including the number of times the plurality of geographic locations 302 are to be indexed, and then the processing circuit can perform the indexing on the plurality of geographic locations the number of times according to the input parameter.

For example, in FIG. 3C, there is illustrated indexing instance A 316, indexing instance B 318, and indexing instance C 320. These indexing instances can also be referred to as search trees. At each instance where the geographic area 300 is indexed for the location type, four new random geographic locations 302 are chosen to create new first sections 310 and new second sections 312. In some embodiments, at each index instance (e.g., indexing instance A 316, indexing instance B 318, and indexing instance C 320) that occurs for a particular location type, the geographic locations 302 of the particular location type are assigned to a new corresponding first section 310 and second section 312 based on how the first and second sections are drawn in the indexing instance.

Indexing instance A 316, indexing instance B 318, and indexing instance C 320 are each divided using the steps described above with respect to FIG. 3B. In some embodiments, populating the list of locations includes the processing circuit being configured to populate the list of locations with the geographic locations assigned to the corresponding second section for each indexing instance of the input location type. For example, the total list of geographic locations 302 output will include all of the geographic locations 302 in the second section 312 where the present location 308 is located in indexing instance A 316, in indexing instance B 318, and indexing instance C 320. Each of the geographic locations 302 in the corresponding second section 312 for each indexing instance or search tree is then compiled into a single list and then sorted from closest to furthest to the present location 308. The distance from each geographic location 302 in the list is also included in the compiled list.

As described above, in some embodiments, the sorted list only includes the unique identifiers for the geographic locations 302. The sorted list can be converted by the processing circuit to human-interpretable addresses or locations by using the location data hash map 218 from FIG. 2A.

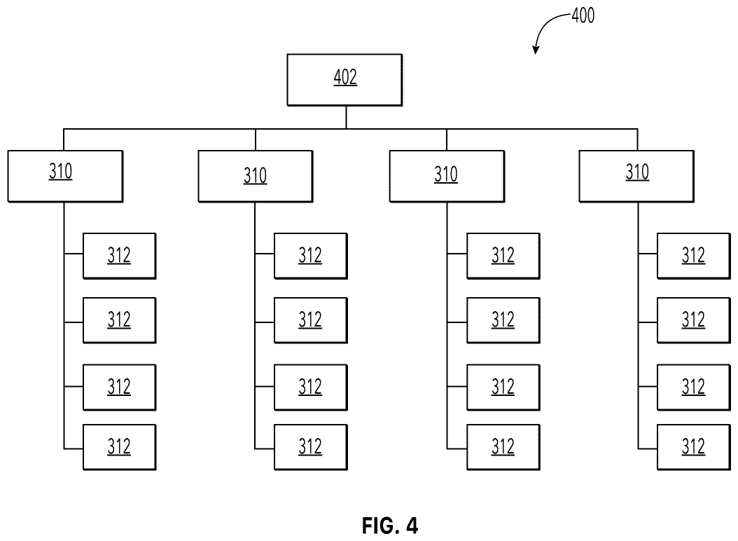

FIG. 4 illustrates another visualization of a search tree 400. This is similar to the visualization in FIG. 3B in that the geographic area 300 has been divided into four quadrants (e.g., first section 310), and then each first section 310 has been divided into four sub-quadrants. In this visualization, the search tree 400 has a root node 402 which effectively refers to the entire search tree 400 or the indexing instance for this location type, which can be, for example, all the restaurants.

In this case, the root node 402 includes the four quadrants or four first sections 310, and each first section 310 is divided into four sub-quadrants, or second sections 312.

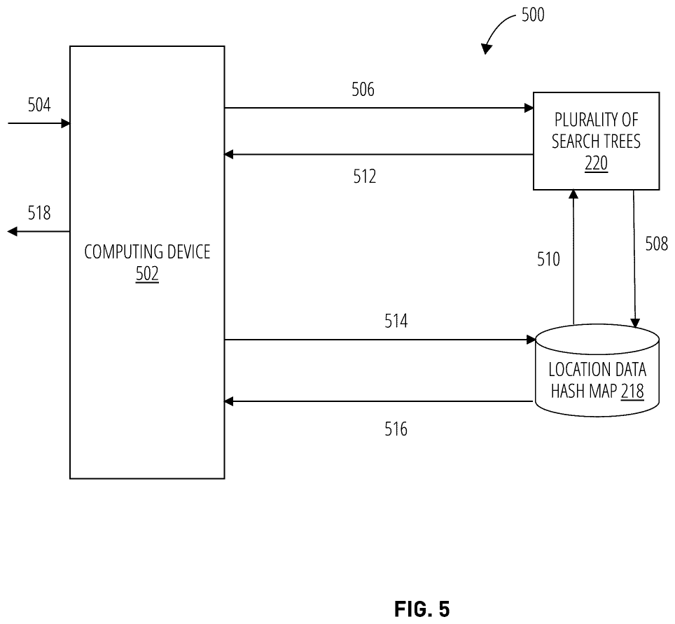

FIG. 5 illustrates an example system 500 according to some embodiments of the present disclosure and provides an example of how a user might interact with the plurality of search trees 220 or search forest 314 after they have been indexed as described above. A user may wish to utilize the system 500 to determine the list of locations that are closest to the user based on a certain location type. In this example, the user may need to repair a tire. The user may utilize a computing device 502 such as their mobile device or smart phone, to access the plurality of search trees 220 and the location data hash map 218, maintained in the database 206 described above, to determine the closest tire repair service center.

In some embodiments, as shown at 504, the computing device 502 may receive, as input from the user (or the GPS of the computing device 502), the present location 308 of the user and/or the computing device 502. At 506, the latitude and longitude or other location identifier of the present location 308 is shared with the database 206 and the plurality of search trees 220 and the processing circuit of the database 206 or the computing device 502 is configured to determine which sub-quadrant the present location 308 is located within. The processing circuit determines this for each of the search trees for the location type. For example, in FIG. 3C, there are three search trees (e.g., indexing instance A 316, indexing instance B 318, and indexing instance C 320) for the location type. Using this same example, in some embodiments, the processing circuit is configured to determine the sub-quadrant the present location 308 is located within for each of the three search trees.

Once these are determined, the unique identifiers of each geographic location within those three sub-quadrants is also determined and added to a list. At 508, the processing circuit is configured to then query the location data hash map 218 to determine the latitude and longitudes of all the geographic locations in the three sub-quadrants on the list. At 510, the location data hash map 218 returns the latitude and longitude for each of the unique identifiers in the three sub-quadrants on the list. Then, the distance between each of the geographic locations in the list is determined by comparing their respective longitude and latitudes to the longitude and latitude of the present location 308.

The list is then sorted based on the distances calculated and at 512, the list is returned to the computing device 502. At 514, the computing device 502 may further query the location data hash map 218 to convert the unique identifiers of the geographic locations into human-interpretable locations. For example, the computing device 502 can query the location data hash map 218 to convert the unique identifiers of the sorted list into the human-readable or interpretable physical address of each location. At 516, the location data hash map 218 then returns the human-interpretable addresses of the geographic locations on the sorted list. At 518, these human-interpretable locations can then be output to the user by displaying the locations on a map on at GUI of the computing device 502. The user can then select which of the geographic locations the user wishes to travel to. In this example, the locations are tire repair service stations. As such, the GUI can display the locations of the tire repair stations in any suitable manner (e.g., on a map). For example, the GUI can prompt the user to select the closest (or another) tire repair service center and display to the user directions to get to the closest service center.

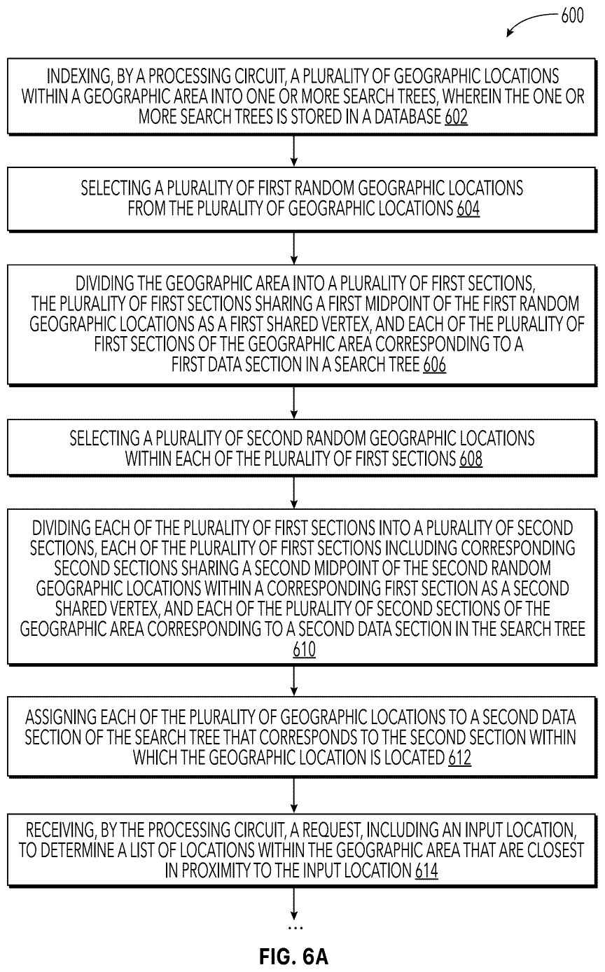

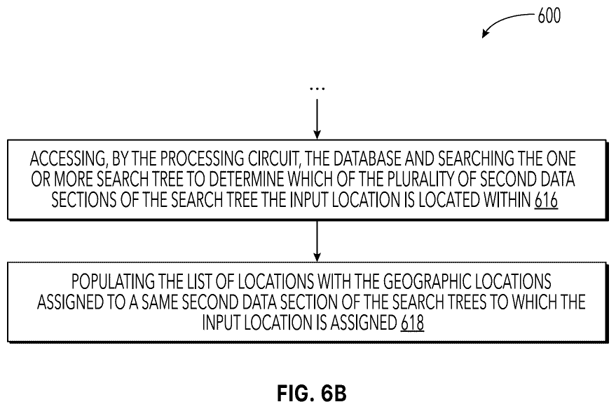

FIG. 6A and FIG. 6B include a flow chart illustrating operations performed in an example method 600 for identifying locations in proximity to another location in reverse geo-searching as described herein. A portion of the operations performed in the example method 600 is illustrated in FIG. 6A and then the remainder of the operations are depicted in the flow chart in FIG. 6B. As shown at block 602, the method 600 includes indexing, by a processing circuit, a plurality of geographic locations within a geographic area into one or more search trees, wherein the one or more search trees is stored in a database. In some embodiments, each of the one or more search trees is a data structure divided into a plurality of first data sections, and each of the plurality of first data sections is divided into a plurality of second data sections, wherein indexing the plurality of geographic locations into the one or more search trees includes various operations described below. As shown at block 604, selecting a plurality of first random geographic locations from the plurality of geographic locations. As shown at block 606, the method 600 includes dividing the geographic area into a plurality of first sections, the plurality of first sections sharing a first midpoint of the first random geographic locations as a first shared vertex, and each of the plurality of first sections of the geographic area corresponding to a first data section in a search tree.

As shown at block 608, the method 600 includes selecting a plurality of second random geographic locations within each of the plurality of first sections. As shown at block 610, the method 600 includes dividing each of the plurality of first sections into a plurality of second sections, each of the plurality of first sections including corresponding second sections sharing a second midpoint of the second random geographic locations within a corresponding first section as a second shared vertex, and each of the plurality of second sections of the geographic area corresponding to a second data section in the search tree. As shown at block 612, the method 600 includes assigning each of the plurality of geographic locations to a second data section of the search tree that corresponds to the second section within which the geographic location is located. As shown at block 614, the method 600 includes receiving, by the processing circuit, a request, including an input location, to determine a list of locations within the geographic area that are closest in proximity to the input location.

FIG. 6B includes a flow chart illustrating additional operations performed in the example method 600 from FIG. 6A. As shown at block 616, the method 600 includes accessing, by the processing circuit, the database and searching the one or more search tree to determine which of the plurality of second data sections of the search tree the input location is located within. As shown at block 618, the method 600 includes populating the list of locations with the geographic locations assigned to a same second data section of the search trees to which the input location is assigned.

Additionally, in some embodiments, the method 600 further includes indexing the plurality of geographic locations based on a location type of the plurality of geographic locations, wherein the method includes generating a search tree for each location type of the plurality of geographic locations. In some embodiments, selecting the plurality of first random geographic locations includes selecting four random geographic locations having a same location type as a corresponding search tree being indexed, the first four random geographic locations being non-colinear with respect to each other. In some embodiments, the first sections are first quadrants of the geographic area. In some embodiments, selecting the plurality of second random geographic locations within each of the first sections includes selecting four random geographic locations within each of the first quadrants, the plurality of second four random geographic locations being non-colinear with respect to each other. In some embodiments, the second sections are second quadrants within each of the first quadrants.

In some embodiments of the method 600, each of the plurality of geographic locations comprises a unique identifier to a hash map, the unique identifier being a reference to a corresponding data structure entry in the hash map, the data structure entry corresponding to one of the plurality of geographic locations and including characteristics of the geographic location; and wherein indexing the plurality of geographic locations includes indexing the unique identifiers of the plurality of geographic locations.

In some embodiments of the method 600, the characteristics include at least a physical street address, a city, a zip code, a postal code, or a unique location code for real property associated with the corresponding geographic location.

In some embodiments, the method 600 further includes determining, by the processing circuit, a distance between the input location and each of the geographic locations in the list of locations; and sorting, by the processing circuit, the list of locations based on the distance between the input location and a corresponding geographic location, where the list of locations is sorted from closest to furthest from the input location.

In some embodiments, the method 600 further includes outputting, by the processing circuit, the list of locations comprising: the unique identifier for each of the geographic locations on the list; and the distance between each geographic location and the input location.

In some embodiments, the method 600 further includes receiving, by the processing circuit, as an input parameter, a number of times the plurality of geographic locations are to be indexed; and performing, by the processing circuit, the indexing on the plurality of geographic locations the number of times according to the input parameter; wherein, at each indexing instance that occurs for a particular location type, the geographic locations of the particular location type are assigned to a new corresponding second section based on how the first and second sections are drawn in the indexing instance; and wherein populating the list of locations comprises populating the list of locations with the geographic locations assigned to the corresponding second section for each indexing instance of the input location type.

In some embodiments, the method 600 further includes receiving, by the processing circuit, an input parameter indicating a number of geographic locations to list that are closest to the input location; and wherein populating the list of locations comprises only listing the locations up to a quantity equal to the input parameter.

Some embodiments of the disclosed system may be implemented, for example, using a storage medium, a computer-readable medium or an article of manufacture which may store an instruction or a set of instructions that, when executed by a machine (e.g., processor, processing circuit, or microcontroller), may cause the machine to perform a method and/or operations in accordance with embodiments of the disclosure. In addition, a server or database server may include machine readable media configured to store machine executable program instructions. Such a machine may include, for example, any suitable processing platform, computing platform, computing device, processing device, computing system, processing system, computer, processor, or the like, and may be implemented using any suitable combination of hardware, software, firmware, or a combination thereof and utilized in systems, subsystems, components, or sub-components thereof. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

The subject matter disclosed herein can be implemented in or with software in combination with hardware and/or firmware. For example, the subject matter described herein can be implemented in or with software executed by a processor or processing unit. In one example implementation, the subject matter described herein can be implemented using a computer readable medium having stored thereon computer executable instructions that when executed by a processor of a computer control the computer to perform steps. Example computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A method comprising:
indexing, by a processing circuit, a plurality of geographic locations within a geographic area into one or more search trees, wherein the one or more search trees is stored in a database;
wherein each of the one or more search trees is a data structure divided into a plurality of first data sections, and each of the plurality of first data sections is divided into a plurality of second data sections, wherein indexing the plurality of geographic locations into the one or more search trees comprises:
selecting a plurality of first random geographic locations from the plurality of geographic locations;
dividing the geographic area into a plurality of first sections, the plurality of first sections sharing a first midpoint of the first random geographic locations as a first shared vertex, and each of the plurality of first sections of the geographic area corresponding to a first data section in a search tree;
selecting a plurality of second random geographic locations within each of the plurality of first sections;
dividing each of the plurality of first sections into a plurality of second sections, each of the plurality of first sections including corresponding second sections sharing a second midpoint of the second random geographic locations within a corresponding first section as a second shared vertex, and each of the plurality of second sections of the geographic area corresponding to a second data section in the search tree; and
assigning each of the plurality of geographic locations to a second data section of the search tree that corresponds to the second section within which the geographic location is located;
receiving, by the processing circuit, a request, including an input location, to determine a list of locations within the geographic area that are closest in proximity to the input location;
accessing, by the processing circuit, the database and searching the one or more search tree to determine which of the plurality of second data sections of the search tree the input location is located within; and
populating the list of locations with the geographic locations assigned to a same second data section of the search trees to which the input location is assigned.

2. The method of claim 1, wherein the method further includes indexing the plurality of geographic locations based on a location type of the plurality of geographic locations, wherein the method includes generating a search tree for each location type of the plurality of geographic locations;
wherein selecting the plurality of first random geographic locations includes selecting four random geographic locations having a same location type as a corresponding search tree being indexed, the first four random geographic locations being non-colinear with respect to each other;
wherein the first sections are first quadrants of the geographic area;
wherein selecting the plurality of second random geographic locations within each of the first sections includes selecting four random geographic locations within each of the first quadrants, the plurality of second four random geographic locations being non-colinear with respect to each other; and
wherein the second sections are second quadrants within each of the first quadrants.

3. The method of claim 1, wherein each of the plurality of geographic locations comprises a unique identifier to a hash map, the unique identifier being a reference to a corresponding data structure entry in the hash map, the data structure entry corresponding to one of the plurality of geographic locations and including characteristics of the geographic location; and
wherein indexing the plurality of geographic locations includes indexing the unique identifiers of the plurality of geographic locations.

4. The method of claim 3, wherein the characteristics include at least a physical street address, a city, a zip code, a postal code, or a unique location code for real property associated with the corresponding geographic location.

5. The method of claim 3, further comprising:
determining, by the processing circuit, a distance between the input location and each of the geographic locations in the list of locations; and
sorting, by the processing circuit, the list of locations based on the distance between the input location and a corresponding geographic location, where the list of locations is sorted from closest to furthest from the input location.

6. The method of claim 5, further comprising:
outputting, by the processing circuit, the list of locations comprising:
the unique identifier for each of the geographic locations on the list; and
the distance between each geographic location and the input location.

7. The method of claim 1, further comprising:
receiving, by the processing circuit, as an input parameter, a number of times the plurality of geographic locations are to be indexed; and
performing, by the processing circuit, the indexing on the plurality of geographic locations the number of times according to the input parameter;
wherein, at each indexing instance that occurs, at least some of the geographic locations are assigned to a new corresponding second data section of a new search tree based on how the first and second sections are drawn in the indexing instance; and
wherein populating the list of locations comprises populating the list of locations with the geographic locations assigned to the corresponding second data section for each indexing instance.

8. The method of claim 1, further comprising:
receiving, by the processing circuit, an input parameter indicating a number of geographic locations to list that are closest to the input location; and
wherein populating the list of locations comprises only listing the locations up to a quantity equal to the input parameter.

9. A computing apparatus comprising:
a processing circuit; and
a memory storing executable instructions thereon which, when executed by the processing circuit, configure the processing circuit to:
index a plurality of geographic locations within a geographic area into one or more search trees, wherein the one or more search trees is stored in a database;
wherein each of the one or more search trees is a data structure divided into a plurality of first data sections, and each of the plurality of first data sections is divided into a plurality of second data sections, wherein indexing the plurality of geographic locations includes the processing circuit being configured to:
select a plurality of first random geographic locations from the plurality of geographic locations;
divide the geographic area into a plurality of first sections, the plurality of first sections sharing a first midpoint of the first random geographic locations as a first shared vertex, and each of the plurality of first sections of the geographic area corresponding to a first data section in a search tree;
select a plurality of second random geographic locations within each of the plurality of first sections;
divide each of the plurality of first sections into a plurality of second sections, each of the plurality of first sections including corresponding second sections sharing a second midpoint of the second random geographic locations within a corresponding first section as a second shared vertex, and each of the plurality of second sections of the geographic area corresponding to a second data section in the search tree; and
assign each of the plurality of geographic locations to a second data section of the search tree that corresponds to the second section within which the geographic location is located;
receive, by the processing circuit, a request, including an input location, to determine a list of locations within the geographic area that are closest in proximity to the input location;
access, by the processing circuit, the database and searching the one or more search tree to determine which of the plurality of second data sections of the search tree the input location is located within; and
populate the list of locations with the geographic locations assigned to a same second data section of the search trees to which the input location is assigned.

10. The computing apparatus of claim 9, wherein the processing circuit is further configured to index the plurality of geographic locations based on a location type of the plurality of geographic locations, wherein the processing circuit is further configured to generate a search tree for each location type of the plurality of geographic locations;
wherein selecting the plurality of first random geographic locations includes selecting four random geographic locations having a same location type as a corresponding search tree being indexed, the first four random geographic locations being non-colinear with respect to each other;
wherein the first sections are first quadrants of the geographic area;
wherein selecting the plurality of second random geographic locations within each of the first sections includes selecting four random geographic locations within each of the first quadrants, the plurality of second four random geographic locations being non-colinear with respect to each other; and
wherein the second sections are second quadrants within each of the first quadrants.

11. The computing apparatus of claim 9, wherein each of the plurality of geographic locations comprises a unique identifier to a hash map, the unique identifier being a reference to a corresponding data structure entry in the hash map, the data structure entry corresponding to one of the plurality of geographic locations and including characteristics of the geographic location; and
wherein indexing the plurality of geographic locations includes the processing circuit being configured to index the unique identifiers of the plurality of geographic locations.

12. The computing apparatus of claim 11, wherein the characteristics include at least a physical street address, a city, a zip code, a postal code, or a unique location code for real property associated with the corresponding geographic location.

13. The computing apparatus of claim 11, wherein the instructions further configure the processing circuit to:
determine a distance between the input location and each of the geographic locations in the list of locations; and
sort the list of locations based on the distance between the input location and a corresponding geographic location, where the list of locations is sorted from closest to furthest from the input location.

14. The computing apparatus of claim 13, wherein the instructions further configure the processing circuit to:
output the list of locations comprising:
the unique identifier for each of the geographic locations on the list; and
the distance between each geographic location and the input location.

15. The computing apparatus of claim 9, wherein the instructions further configure the processing circuit to:
receive, as an input parameter, a number of times the plurality of geographic locations are to be indexed; and
perform the indexing on the plurality of geographic locations the number of times according to the input parameter;
wherein, at each index instance that occurs, at least some of the geographic locations are assigned to a new corresponding second data section of a new search tree based on how the first and second sections are drawn in the indexing instance; and
wherein populating the list of locations includes the processing circuit being configured to populate the list of locations with the geographic locations assigned to the corresponding second data section for each indexing instance.

16. The computing apparatus of claim 9, wherein the instructions further configure the processing circuit to:
receive an input parameter indicating a number of geographic locations to list that are closest to the input location; and
wherein populating the list of locations includes the processing circuit being configured to only list the locations up to a quantity equal to the input parameter.

17. A non-transitory computer-readable storage medium, the computer-readable storage medium including instructions that when executed by a processing circuit, configure the processing circuit to:
index a plurality of geographic locations within a geographic area into one or more search trees, wherein the one or more search trees is stored in a database;
wherein each of the one or more search trees is a data structure divided into a plurality of first data sections, and each of the plurality of first data sections is divided into a plurality of second data sections, wherein indexing the plurality of geographic locations includes the processing circuit being configured to:
select a plurality of first random geographic locations from the plurality of geographic locations;
divide the geographic area into a plurality of first sections, the plurality of first sections sharing a first midpoint of the first random geographic locations as a first shared vertex, and each of the plurality of first sections of the geographic area corresponding to a first data section in a search tree;
select a plurality of second random geographic locations within each of the plurality of first sections;
divide each of the plurality of first sections into a plurality of second sections, each of the plurality of first sections including corresponding second sections sharing a second midpoint of the second random geographic locations within a corresponding first section as a second shared vertex, and each of the plurality of second sections of the geographic area corresponding to a second data section in the search tree; and
assign each of the plurality of geographic locations to a second data section of the search tree that corresponds to the second section within which the geographic location is located;
receive, by the processing circuit, a request, including an input location, to determine a list of locations within the geographic area that are closest in proximity to the input location;
access, by the processing circuit, the database and searching the one or more search tree to determine which of the plurality of second data sections of the search tree the input location is located within; and
populate the list of locations with the geographic locations assigned to a same second data section of the search trees to which the input location is assigned.

18. The computer-readable storage medium of claim 17, wherein the processing circuit is further configured to index the plurality of geographic locations based on a location type of the plurality of geographic locations, wherein the processing circuit is further configured to generate a search tree for each location type of the plurality of geographic locations;
wherein selecting the plurality of first random geographic locations includes selecting four random geographic locations having a same location type as a corresponding search tree being indexed, the first four random geographic locations being non-colinear with respect to each other;
wherein the first sections are first quadrants of the geographic area;
wherein selecting the plurality of second random geographic locations within each of the first sections includes selecting four random geographic locations within each of the first quadrants, the plurality of second four random geographic locations being non-colinear with respect to each other; and
wherein the second sections are second quadrants within each of the first quadrants.

19. The computer-readable storage medium of claim 17, wherein each of the plurality of geographic locations comprises a unique identifier to a hash map, the unique identifier being a reference to a corresponding data structure entry in the hash map, the data structure entry corresponding to one of the plurality of geographic locations and including characteristics of the geographic location; and
wherein index the plurality of geographic locations comprises indexing the unique identifiers of the plurality of geographic locations.

20. The computer-readable storage medium of claim 19, wherein the characteristics include at least a physical street address, a city, a zip code, a postal code, or a unique location code for real property associated with the corresponding geographic location;
wherein the instructions further configure the processing circuit to:
determine a distance between the input location and each of the geographic locations in the list of locations; and
sort the list of locations based on the distance between the input location and a corresponding geographic location, where the list of locations is sorted from closest to furthest from the input location; and
wherein the instructions further configure the processing circuit to:
output the list of locations comprising:
the unique identifier for each of the geographic locations on the list; and
the distance between each geographic location and the input location.
